(19) United States
(12) Patent Application Publication
(10) Pub. No.: US 2017/0308542 A1
(43) Pub. Date: Oct. 26, 2017

(54) FILE SYSTEM CONFIGURATION DATA STORAGE

(71) Applicant: HEWLETT PACKARD ENTERPRISE DEVELOPMENT LP, Houston, TX (US)

(72) Inventors: Prashanth Venkatachalam, Bangalore (IN); Kishore Kumar Muppirala, Bangalore (IN); Rajagopal Chellam, Bangalore (IN)

(73) Assignee: HEWLETT PACKARD ENTERPRISE DEVELOPMENT LP, Houston, TX (US)

(21) Appl. No.: 15/521,350

(22) PCT Filed: Jan. 15, 2015
(86) PCT No.: PCT/US2015/011607

§ 371 Date: Apr. 24, 2017

(30) Foreign Application Priority Data
Nov. 1, 2014 (IN) 5482/CHE/2014

(51) Int. Cl. G06F 17/30

(52) U.S. Cl. CPC G06F 17/30091; G06F 17/30227; G06F 17/30117; G06F 17/30123; G06F 17/30174

(57) ABSTRACT

A request to create a domain is received. The request is associated with a configuration parameter. The domain is indicative of a storage device comprising at least one volume for storing data pertaining to a file system (FS). Further, based on the configuration parameter, a configuration file set is created within the domain. The configuration file set is activated to load data structures corresponding to the configuration file set in a memory. The activation is based on a command received from an upper layer to perform an action on the configuration file set. Furthermore, configuration data is stored within the configuration file set when the action is performed on the configuration file set.

### BACKGROUND

File systems (FSs) are used for storage and retrieval of data in a computing environment. In order to deploy a FS, configuration data pertaining to the FS has to be accessed. Configuration data relates to information used while configuring the file system. Examples of the configuration data may include mount point, storage device location, structure of the file system, operating systems supported by the FS, number of users accessing the file system, and the like.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the figures to reference like features and components:

FIG. 1A illustrates components of a data storage system, according to an example of the present subject matter.

FIG. 1B illustrates a network implementation of the data storage system, according to another example of the present subject matter.

FIG. 2A illustrates a method for storing configuration data pertaining to a file system (FS) within the FS, according to an example of the present subject matter.

FIG. 2B illustrate method for storing configuration data pertaining to a file system (FS) within the FS, according to other examples of the present subject matter.

FIG. 3 illustrates a computer readable medium storing instructions for storing configuration data pertaining to a file system (FS) within the FS, according to an example of the present subject matter.

### DETAILED DESCRIPTION

Generally, configuration data pertaining to a file system (FS) is used to deploy the FS. The configuration data, if stored within the FS, cannot be accessed without deploying the FS. Therefore, the configuration data is stored locally on a computing system, separately from the FS, for accessing the FS. For example, a data management system may store the configuration data for controlling and implementing the FS. The configuration data may include information that may be utilized by the FS as well as various components of the data management system that may control and implement the FS. The components may include, but are not limited to, protocol layers and management layers, which interact with the FS. In an example, the configuration data may be stored on a boot disk of a computing system. In order to access the FS, the computing system first reads the configuration data stored locally thereon to access the FS.

When the FS has to be moved to a different location, the configuration data associated with the FS also has to be transferred. However, as the configuration data is stored separately from the FS, the configuration data has to be moved separately. The separate movement of the configuration data is error-prone. Also, bugs or errors may appear in the configuration data and may result in the FS becoming inaccessible. Moreover, separately storing the configuration data results in the FS not being self-describing and detachable.

According to various examples, systems and methods for storing FS configuration data, also referred to as configuration data, are disclosed. The present subject matter may include a data storage system. The data storage system may store the configuration data pertaining to the FS within the FS. The configuration data may be understood as metadata associated with the FS. For example, the configuration data may include information about the mount point and device location. The configuration data may also include information pertaining to the FS, configuration information pertaining to upper layers may communicate with the FS, layout of the FS, and information pertaining to logical unit numbers (LUNs) associated with the FS. In an example, the upper layers may be a stackable filesystem or another application which performs management of servers, such as failover. Examples of the upper layers may include, but are not limited to, a protocol layer, a management layer, and a configuration layer.

As mentioned above, the configuration data can be used for accessing the FS. The configuration data may also include information pertaining to identity and security of the FS. The identity information may include information about devices that belong to the FS, mount point where the FS has to be mounted, and information about whether the FS belongs to some arbitrary group or not. Further, the security information may include details about who is allowed to mount the FS or an encryption key which may be used to access the FS, and the like.

In an example, the data storage system facilitates in storing the configuration data within the FS. The data storage system may receive a request from a user for creating a domain. A domain is indicative of a storage device, containing at least one volume for storing data about the FS, in a physical storage layer of a computing device. In the present example, the user may be a system administrator. The data storage system may determine whether or not the request is associated with a configuration parameter. In the present example, the configuration parameter may be understood as an indicator for creating a configuration file set within the domain. If the configuration parameter is associated with the request, the data storage system may create the configuration file set to store the configuration data within the domain.

In an implementation, the configuration file set may be a hidden file set and may not be accessible to users including the system administrator. The configuration file set may be accessed by the upper layers to interact with the FS without activating or deploying the FS. In an example, the upper layers may be a stackable FS or another application for managing servers associated with the FS. For example, in case of a failover, the management layer would like to know as to which FS has to be mounted onto which mountpoint. Such information may be stored in the configuration file set as this information may be accessed by the management layer before mounting the FS. In an example, the configuration file set may be a BLOB file set. The BLOB file set facilitates in storing configuration data pertaining to multiple FS. In addition, the BLOB file set may be configured to store large data files.

In another example, the data storage system may associate a flag with the domain to indicate that the domain includes the configuration file set. For example, the FS has to be activated, i.e., made accessible using the configuration data, before any data may be read from or written into the FS. In order to access the configuration data, prior to activation of the FS, the upper layers, such as protocol services, platform management layer, and configuration layer, may communicate with the configuration file set. In an alternative example, the data storage system may host multiple file systems. In this case, the upper layers may interact with the configuration file set when the upper layers have to write or modify or update or read configuration data pertaining to another FS in the configuration file set.

In an implementation, a plurality of configuration application programming interfaces (APIs) and configuration input/output controls (ioctls) may be defined for use by the upper layers for accessing the configuration file set. Accordingly, the upper layers may communicate with the configuration file set through the configuration APIs and ioctls that may be defined by the FS.

In operation, when the upper layers have to perform an action on the configuration file set, the upper layers may send a command to the configuration file set. In an example, the upper layers may modify the configuration files when any configuration change may occur on the FS, such as change in number of disks under the FS or change in mountpoint for the FS. For example, if the upper layer has to write the configuration data in a file of the configuration file set, the upper layer may call a write command through the configuration APIs and specify the name of the file in which the upper layer would like to write the configuration data. Upon receiving the write command, the data storage system may determine whether the file specified in the write command exists or not. If the file does not exist, the data storage system may create the file and store the configuration data as provided by the upper layer in the file.

In addition, the data storage system can make changes occurring in the configuration file set as crash consistent. For example, if the FS crashes during a transaction, such as a write operation, on a file of the configuration file set, the data storage system may check whether the transaction was completed before the crash or not. If not, the data storage system may roll back the partially completed transaction and not store any part of the transaction. The data storage system thus ensures that the configuration data stored within the configuration file set is saved in entirety.

In accordance with the examples of the disclosed systems and methods, the configuration data may be stored within the FS in such a manner that the configuration data is accessible by the data storage system before the FS is activated and at the same time is not accessible to or modifiable by the users. The data storage system of the present subject matter therefore associates the configuration data, pertaining to the FS, with the FS by storing the configuration in the FS. Further, the configuration data is made available readily when the FS moves across nodes. Accordingly, the data storage system makes the FS self-describing and provides for a secure movement of the configuration data.

The various systems and the methods are further described in conjunction with the following figures. It should be noted that the description and figures merely illustrate the principles of the present subject matter. Further, various arrangements may be devised that, although not explicitly described or shown herein, embody the principles of the present subject matter and are included within its scope.

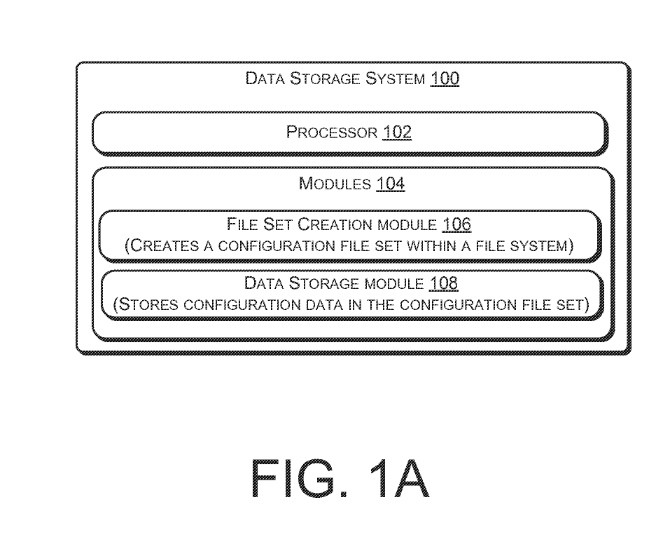

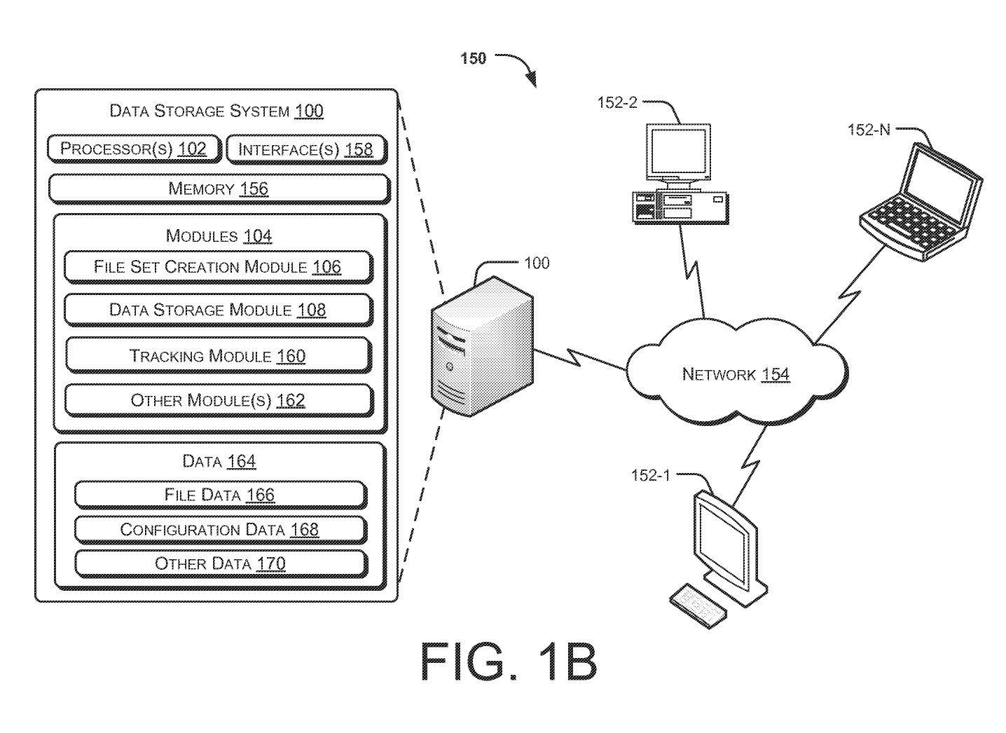

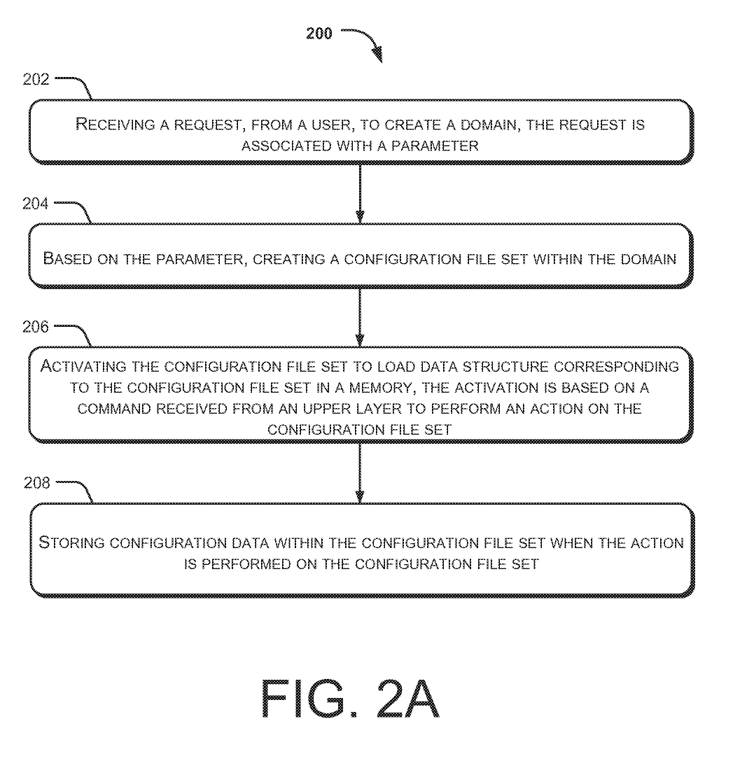

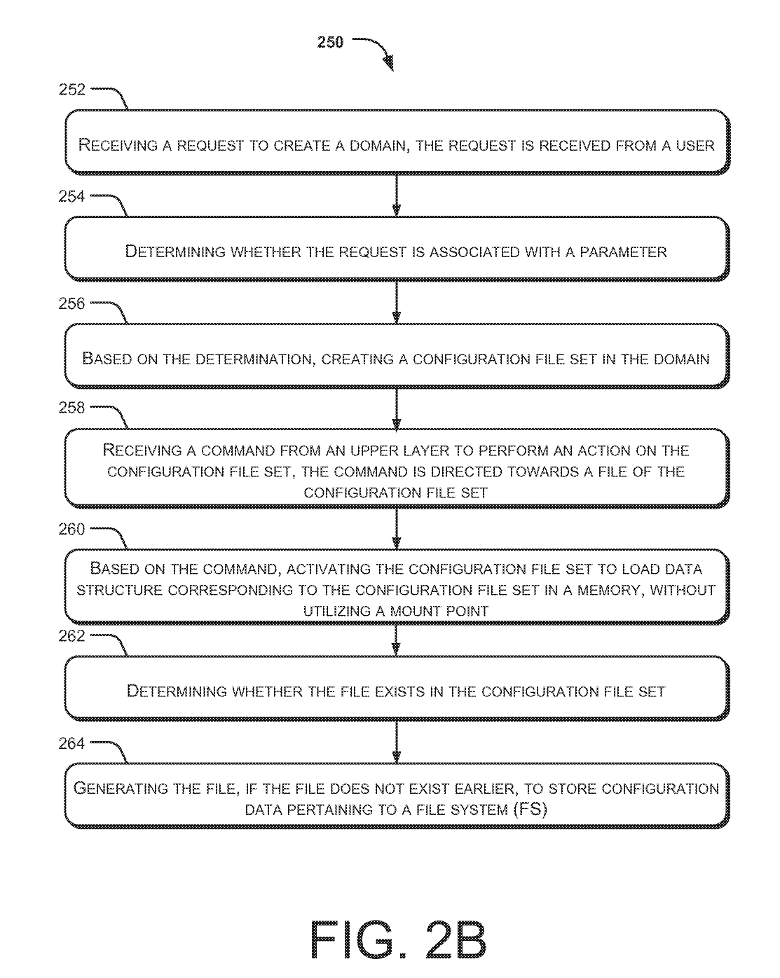

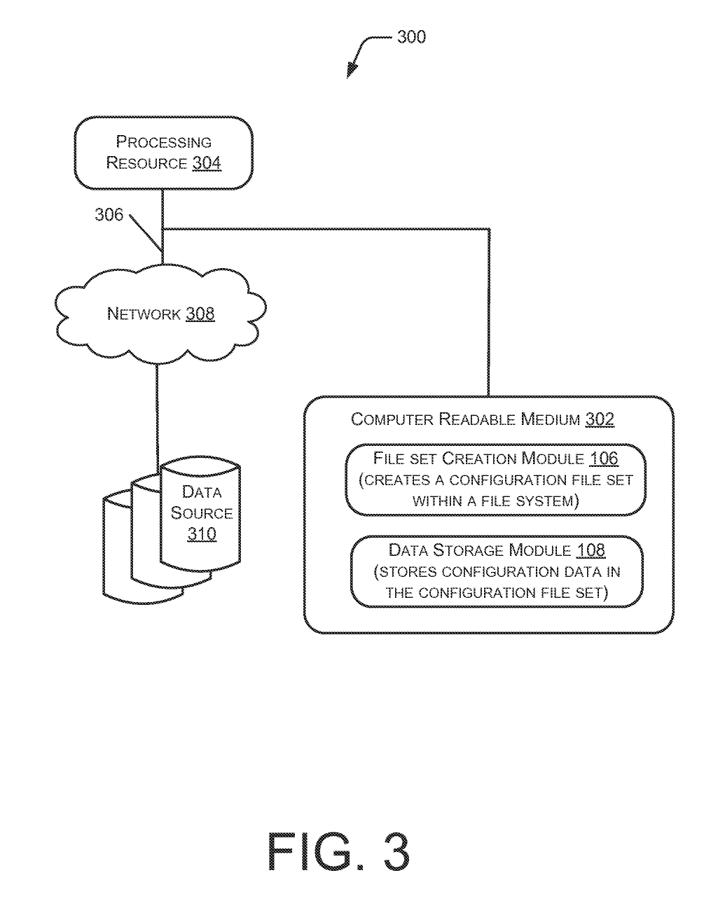

The manner in which the systems and the methods for storage of configuration data within a file system are implemented are explained in details with respect to FIG. 1A, FIG. 1B, FIG. 2A, FIG. 2B, and FIG. 3. While aspects of described systems and methods for file system configuration data storage can be implemented in any number of different computing systems, environments, and/or implementations, the examples and implementations are described in the context of the following system(s).

FIG. 1A illustrates the components of a data storage system 100, according to an example of the present subject matter. In one example, the data storage system 100 may be implemented as any computing system, such as a desktop, a laptop, a server, and the like. In an example, the data storage system 100 can be implemented in a network environment comprising a variety of network devices, including routers, bridges, servers, computing devices, storage devices, etc.

In one implementation, the data storage system 100 includes a processor 102 and modules 104 coupled to the processor 102. The processor 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labeled as “processor(s)”, may be provided through the use of dedicated hardware as well as hardware capable of executing computer-readable instructions.

The modules 104, amongst other things, include routines, programs, objects, components, and data structures, which perform particular tasks or implement particular abstract data types. The modules 104 may also be implemented as, signal processor(s), state machine(s), logic circuitries, and/or any other device or component that manipulates signals based on operational instructions. Further, the modules 104 can be implemented by hardware, by computer-readable instructions executed by a processing unit, or by a combination thereof. In one implementation, the modules 104 include a file set creation module 106 and a data storage module 108.

In an implementation, the file set creation module 106 may create a configuration file set in a file system (FS). For example, the file set creation module 106 may receive a request from a user, such as a system administrator, to create a domain in the data storage system 100 implementing the FS. A domain is indicative of a storage device, containing at least one volume for storing data pertaining to the FS, in a physical storage layer of a computing device. In an example, the domain may be configured within a physical storage layer of the data storage system 100. For example, the physical storage layer may include a hard disk, an optical disk, a magnetic tape, and the like. Further, a volume may be understood as a logical storage unit for storing data in a computing system.

Upon receiving the request, the file set creation module 106 may determine whether the configuration file set is to be created or not. In the present implementation, the file set creation module 106 may parse the request to determine if the request is associated with a configuration parameter. The configuration parameter is indicative of creation of the configuration file set in the domain. In an example, the system administrator may specify a ‘-o blob’ parameter while sending the request for creation of the domain. Upon determining that the request is associated with the ‘-o blob’ parameter, the file set creation module 106 may automatically create the configuration file set within the domain.

In an implementation, the configuration file set may be a BLOB file set. The BLOB file set facilitates in storing data, such as configuration data pertaining to multiple FS, without size constraint. Further, in the present implementation, the BLOB file set is created as a hidden file set and is therefore not visible to users of the FS, including the system administrator. In addition, the BLOB file set thus created is inaccessible by using conventional APIs. The BLOB file set may be accessed by configuration ioctls.

In an implementation, when an upper layer, such as a protocol layer or a management layer, of the FS has to access the BLOB file set, the upper layer may call the BLOB file set. The upper layers may be a stackable filesystem or another application which performs management of servers. In an example, if the upper layer has to write the configuration data pertaining to the FS into the BLOB file set, the upper layer may send a write command to the BLOB file set. As mentioned above, the upper layers may interact with the BLOB file set using configuration ioctls. In the present implementation, the command may be received by the data storage module 108. Upon receiving the command, the data storage module 108 activates the configuration file set, i.e., make the configuration file set accessible for transactions. Further, the data storage module 108 may parse the write command to determine a file name from the BLOB file set in which the configuration data has to be written.

Upon identifying the file name, the data storage module 108 determines whether the file is present in the BLOB file set or not. If the file exists, the data storage module 108 may write the configuration data into the file. On the other hand, if the file does not exist, the data storage module 108 may generate the file in the BLOB file set and then write the configuration therein. Accordingly, the configuration data pertaining to the FS is stored within the FS and yet may be accessed without mounting the FS.

It may be noted that though the configuration file set is described as a BLOB file set in the description, the configuration file set may be in any format and may include any type of data. The process of storage of configuration data pertaining to the FS within the FS is described in greater detail in conjunction with FIG. 1B.

FIG. 1B illustrates a network environment 150 including the data storage system 100 according to another example of the present subject matter. As mentioned previously, the data storage system 100 may be implemented in various computing systems, such as personal computers, servers, etc. The data storage system 100 may be implemented on a network interfaced computing system. In one example, for the purpose of data storage in the network environment 150, the data storage system 100 may communicate with a plurality of user devices 152-1, 152-2, . . . , 152-N over a network 154.

The network 154 may be a wired network, a wireless network or a combination of a wired and wireless network. The network 154 can also be a collection of individual networks, which may use different protocols for communication, interconnected with each other. Further, the network 154 can include various network elements, such as gateways, modems, routers; however, such details have been omitted for ease of understanding. In one example, the network 154 may be a private network, such as an enterprise network, or a public network, such as a cloud network, or a hybrid network. The user devices 152-1, 152-2, . . . , 152-N can be collectively referred to as user devices 152 and individually referred to as a user device 152 hereinafter. The user devices 152 can include, but are not restricted to, desktop computers, laptops, data servers, and the like.

In an implementation, the data storage system 100 includes the processor 102 and a memory 156 connected to the processor 102. The memory 156, communicatively coupled to the processor 102, can include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The data storage system 100 also includes interface(s) 158. The interface(s) 158 may include a variety of interfaces, for example, interface(s) 158 for user device(s), such as the user devices 152 and network devices of the network 154. The interface(s) 158 may include data input and output devices, referred to as I/O devices. The interface(s) 158 facilitate the communication of the data storage system 100 with various communication and computing devices and various communication networks, such as networks that use a variety of protocols, for example, Hypertext Transfer Protocol (HTTP) and Transmission Control Protocol/Internet Protocol (TCP/IP).

Further, in addition to the file set creation module 106 and the data storage module 108, the modules 104 may include a tracking module 160, and other module(s) 162. The other module(s) 162 may include programs or coded instructions that supplement the applications or functions performed by the data storage system 100. The modules 104 may be implemented as described in relation to FIGS. 1A and 1B.

In an example, the data storage system 100 includes data 164. The data 164 may include file data 166, configuration data 168, and other data 170. The other data 170 may include data generated and saved by the modules 104 for implementing various functionalities of the data storage system 100.

In an example, the file set creation module 106 may receive a request from a user to create a domain within the FS. As described above, a domain may be indicative of a storage device, containing at least one volume for storing data pertaining to the FS, in a physical storage layer of a computing device. In an implementation, the FS is a journaling FS that maintains a log, also referred to as a journal, which includes a list of actions performed by the FS. An action may be understood to include a sequence of steps and the FS can treat the sequence of steps as a single operation. Before the FS makes changes in the configuration data, the FS creates an action, in the log, that describes what all steps the FS is about to do. Once all the steps in the action are completed on a storage device, the action is considered as completed.

Upon receiving the request to create the domain, the file set creation module 106 may determine whether the request is associated with the parameter or not. As mentioned above, the system administrator may associate the parameter ‘-o blob’ with the request for creation of the domain. If the request is associated with the parameter, the file set creation module 106 may automatically create a configuration file set within the domain. In an example, the configuration file set is a hidden file set that is created for storing the configuration data pertaining to the FS within the FS. In addition, the file set creation module 106 may associate a flag with the domain to indicate that the domain contains the configuration file set.

In an implementation, the configuration file set may store configuration data pertaining to multiple FS. For example, the configuration file set may be a BLOB file set. In an example, the configuration file set may not support directory hierarchy and therefore, the configuration file set can create the configuration files in a root directory without following a hierarchy.

Once the configuration file set is created, the upper layers, such as a protocol layer, a management layer, or a configuration layer, may interact with the configuration file set to access the configuration data pertaining to the FS. In an example, the upper layers may be a stackable filesystem or another application which performs management of servers. For example, the data storage system 100 may utilize multiple file systems, in such a scenario, the upper layers may belong to different FS. In order to store or read the configuration data pertaining to a FS, the upper layers may communicate with the configuration file set. In an implementation, the upper layers may interact with the configuration file set by utilizing configuration input/output controls (ioctls). In an example, the data storage system 100 may define read and write ioctls for allowing the upper layers to interact with the configuration file set.

In an implementation, when the upper layers send a command to access the configuration file set, the command is received by the data storage module 108. Upon receiving the command, the data storage module 108 may activate the configuration file set within the FS without mounting the FS. For example, the data storage module 108, upon activation, can load data structures corresponding to the configuration file set in the memory 156.

In an example, the configuration file set may store a plurality of files. The data storage module 108 may store the information pertaining to the files within the configuration file set as file data 166. Therefore, the upper layers may have to specify name of a file which the upper layers intend to access from the plurality of files. Accordingly, the commands sent by the upper layers may include the name of the file on which the action is to be performed. In addition, the upper layers may have to specify a buffer and size of the buffer for performing the action. The buffer may be understood as a region of a physical memory storage, such as the memory 156, of the data storage system 100, that may be used to temporarily store data while the data is being moved from one place to another.

For example, when the data storage module 108 receives a read command from the upper layers, the data storage module 108 may parse the command and retrieve the data from the file as specified in the command and store the data in the buffer, which is also specified in the command. The read ioctl may then read the data from the buffer for sharing with the upper layers. In an example, if the buffer size is less than the data being read, the data may be stored in multiple buffers.

In case of a write command, the data storage module 108 may copy the data into the buffer as specified in the write command. Thereafter, the data storage module 108 may determine whether the file as specified in the write command is present in the configuration file set or not. If the file is present in the configuration file set, the data storage module 108 may write the data from the buffer into the file. If the file does not exist in the configuration file set, the data storage module 108 may create the file in the configuration file set before writing the data from the buffer into the file. The data storage module 108 may also store the configuration information as configuration data 168. Accordingly, the data storage module 108 facilitates in creating new files in the configuration file set without sending a separate create command.

In an example, the data storage system 100 facilitates in making the configuration file set failure atomic. In an implementation, the tracking module 160 may maintain a log of a plurality of steps involved in the action performed on the file of the configuration file set. Further, the tracking module 160 may determine if the FS has crashed before completion of the action on the file. If the FS has crashed before completion of the action, the tracking module 160 may determine if a last entry in the log indicates the action is incomplete. If all steps pertaining to the action have been completed, the tracking module 160 may save the changes in the file. On the other hand, if all the steps have not been completed, the tracking module 160 may roll back steps performed for the action before the FS crashed. In other words, the tracking module 160 may not store a partial change in the configuration file set. Therefore, the data storage system 100 ensures that each transaction in the configuration file set be all or nothing.

In another example, the tracking module 160 may facilitate in making the data storage system 100 crash consistent. In an implementation, whenever the files within the configuration file set have to be updated, the tracking module 160 may create a temporary configuration file when a transaction is initiated from an original configuration file associated with the FS. Thereafter, the tracking module 160 may replicate the configuration data from the original configuration file into the temporary configuration file. Once the configuration data is successfully replicated in the temporary configuration file, the tracking module 160 may rename the temporary configuration file as the original configuration file when the transaction is completed. The original configuration file may then be deleted by the tracking module 160.

The data storage system 100 facilitates in storing the configuration data pertaining to the FS within the FS. This enables accessing the configuration data pertaining to the FS even when the FS is offline. Further, the BLOB file set and the APIs provides the data storage system 100 with the ability to hold configuration data pertaining to the FS in the FS and yet access the configuration data without mounting the FS. Further, the configuration data moves along with the FS when the FS is moved across nodes. As the configuration data can be accessed and updated even when the FS is not active, the data storage system 100 provides a detachable and self-describing FS which is independent of externally stored configuration data.

FIGS. 2A and 2B illustrate methods 200 and 250 for file system (FS) configuration data storage, according to an example of the present subject matter. The order in which the methods 200 and 250 are described is not intended to be construed as a limitation, and some of the described method blocks can be combined in a different order to implement the methods 200 and 250, or an alternative method. Additionally, individual blocks may be deleted from the methods 200 and 250 without departing from the spirit and scope of the subject matter described herein. Furthermore, the methods 200 and 250 may be implemented in any suitable hardware, computer-readable instructions, or combination thereof.

The steps of the methods 200 and 250 may be performed by either a computing device under the instruction of machine executable instructions stored on a computer readable medium or by dedicated hardware circuits, microcontrollers, or logic circuits. Herein, some examples are also intended to cover computer readable medium, for example, digital data storage media, which are machine or computer readable and encode machine-executable or computer-executable instructions, where said instructions perform some or all of the steps of the described methods 200 and 250.

With reference to method 200 as depicted in FIG. 2A, at block 202, the method 200 includes receiving a request from a user to create a domain within a file system (FS). The request may be associated with a configuration parameter. In an example, the domain may be indicative of a storage device, containing at least one volume for storing data pertaining to the FS, in a physical storage layer of a computing device. In an implementation, the file set creation module 106 may receive the request from the user to create the domain in the FS.

At block 204, the method 200 includes creating a configuration file set within the domain, based on the configuration parameter. In an implementation, the file set creation module 106 may create the configuration file set within the domain to store configuration data pertaining to the FS. Further, the file set creation module 106 may associate a flag with the configuration file set to indicate that the file set created first in the domain is the configuration file set. In an example, the configuration file set may be a hidden file set and is accessible through configuration application programming interfaces (APIs).

At block 206, the method 200 includes activating the configuration file set to load data structure corresponding to the configuration file set in the memory 156. In an example, the activation is based on a command, received from an upper layer of the FS, to perform an action on at least one file of the configuration file set. In an implementation, the data storage module 108 may receive the command from the upper layers of the FS. Based on the command, the data storage module 108 may activate the configuration file set. The upper layers may interact with the configuration file set by using the configuration APIs and configurations ioctls, such as a read ioctl and a write ioctl.

Further, at block 208, the method 200 may include storing configuration data within the configuration file set when the action is performed on the configuration file set. In an implementation, the data storage module 108 may store the configuration data in the configuration file set.

Referring to FIG. 2B, at block 252, the method 250 may include receiving a request to create a domain within a file system (FS). In an example, the request is received from a user. In an implementation, the file set creation module 106 may receive the request for creation of the domain.

As shown in block 254, the method 250 may include determining whether the request is associated with a parameter. In an implementation, the file set creation module 106 may determine whether or not the request is associated with the parameter. In an example, the user may associate a ‘-o blob’ parameter with the request. The ‘-o blob’ parameter may be indicative of creation of a configuration file set within the domain.

As depicted in block 256, the method 250 may include automatically creating the configuration file set in the domain upon determination of association of the configuration parameter. In an implementation, the file set creation module 106 may create the configuration file set within the domain. In an example, the configuration file set may contain a plurality of files having information pertaining to multiple FS. Further, upon the creation of the configuration file set, the file set creation module 106 may associate a flag with the domain to indicate that the domain includes the configuration file set.

At block 258, the method 250 may include receiving a command from an upper layer to perform an action on the configuration file set. The upper layers may be a stackable filesystem or another application which performs management of servers. In an example, the command is directed towards a file of the configuration file set. In an implementation, the data storage module 108 may receive the command from the upper layers of the FS. Examples of the upper layers may include, but are not limited to, a protocol layer, a manageability layer, and a configuration layer. As the configuration file set may include a plurality of files, the upper layers may indicate name of a domain, name of a file within the domain, a buffer, and a size of the buffer, in the command. In the present implementation, the upper layers may interact with the configuration file set using specialized interfaces, such as read and write ioctls.

At block 260, the method 250 may include activating the configuration file set to load data structures in the memory 156 of the data storage system 100 without utilizing a mount point. In an implementation, the data storage module 108 may activate the configuration file set upon receiving the command from the upper layers. In an example, the data storage module 108 may activate the configuration file set without utilizing the mount point.

Further, at block 262, the method 250 may include determining whether the file exists in the configuration file set. In an implementation, the data storage module 108 may determine whether the file as indicated in the command sent by the upper layer exists or is a new file.

At block 264, the method 250 may include generating the file, if the file does not exist earlier. The file is used to store the configuration data pertaining to the FS. In an implementation, if the file is present in the configuration file set, the data storage module 108 may perform the action as indicated in the command. On the other hand, if the file is new, the data storage module 108 may first generate the file within the configuration file set before performing the action on the file.

FIG. 3 illustrates an example network environment 300 implementing a non-transitory computer readable medium 302 for file system (FS) configuration data storage, according to an example of the present subject matter. The network environment 300 may be a public networking environment or a private networking environment. In one implementation, the network environment 300 includes a processing resource 304 communicatively coupled to the non-transitory computer readable medium 302 through a communication link 306.

For example, the processing resource 304 can be a processor of a computing system, such as the data storage system 100. The non-transitory computer readable medium 302 can be, for example, an internal memory device or an external memory device. In one implementation, the communication link 306 may be a direct communication link, such as one formed through a memory read/write interface. In another implementation, the communication link 306 may be an indirect communication link, such as one formed through a network interface. In such a case, the processing resource 304 can access the non-transitory computer readable medium 302 through a network 308. The network 308 may be a single network or a combination of multiple networks and may use a variety of communication protocols.

The processing resource 304 and the non-transitory computer readable medium 302 may also be communicatively coupled to data sources 310 over the network 308. The data sources 310 can include, for example, databases and computing devices. The data sources 310 may be used by the database administrators and other users to communicate with the processing resource 304.

In one implementation, the non-transitory computer readable medium 302 includes a set of computer readable instructions, such as the file set creation module 106 and the data storage module 108. The set of computer readable instructions, referred to as instructions hereinafter, can be accessed by the processing resource 304 through the communication link 306 and subsequently executed to perform acts for network service insertion.

For discussion purposes, the execution of the instructions by the processing resource 304 has been described with reference to various components introduced earlier with reference to description of FIGS. 1A and 1B.

In an example, on execution by the processing resource 304, the file set creation module 106 may create a configuration file set within a domain of a file system (FS). In an example, the domain may be understood as a storage device, containing at least one volume for storing data pertaining to the FS, in a physical storage layer of a computing device. In an implementation, the configuration file set is created upon receiving a request from a user, such as a system administrator, to create the domain within the FS. In an example, the request is associated with a configuration parameter. The user may specify a ‘-o blob’ parameter with the request based on which the file set creation module 106 may automatically create the configuration file set along with the domain. Further, the file set creation module 106 may associate a flag with the domain to indicate that the domain includes the configuration file set.

Further, the data storage module 108 may activate the configuration file set without utilizing a mount point. The activation is based on a command received from an upper layer of the FS to perform an action on the configuration file set. As described above, the upper layers may communicate with the configuration file set by using configuration application programming interfaces (APIs). For example, the upper layers may use read and write ioctls to access the configuration file set. Further, the data storage module 108 may generate a file in the configuration file set if the file does not exist earlier. The file may include configuration data pertaining to the FS.

Although implementations of file system (FS) configuration data storage, have been described in language specific to structural features and/or methods, it is to be understood that the present subject matter is not necessarily limited to the specific features or methods described. Rather, the specific features and methods are disclosed and explained in the context of a few implementations for file system (FS) configuration data storage.

I/We claim:

1. A method for storing configuration data pertaining to a file system (FS), the method comprising:
receiving, by a processor, a request to create a domain, wherein the request is associated with a parameter, and wherein the domain is indicative of a storage device comprising at least one volume for storing data pertaining to the FS;
based on the parameter, creating, by the processor, a configuration file set within the domain;
activating, by the processor, the configuration file set to load data structures corresponding to the configuration file set in a memory, wherein the activation is based on a command received from an upper layer to perform an action on the configuration file set; and
storing, by the processor, configuration data within the configuration file set when the action is performed on the configuration file set.

2. The method as claimed in claim 1 further comprising determining, by the processor, whether a file exists in the configuration file set, wherein the file is generated in the configuration file set, if the file does not exist, to store the configuration data pertaining to the FS in the file.

3. The method as claimed in claim 1, wherein the command is one of a read command and a write command.

4. The method as claimed in claim 1, wherein the upper layer communicates with the configuration file set using configuration application programming interfaces (APIs).

5. The method as claimed in claim 1, wherein the configuration file set is a hidden file set.

6. The method as claimed in claim 1 further comprises associating, by the processor, a flag with the domain, wherein the flag is indicative of presence of the configuration file set in the domain.

7. The method as claimed in claim 1, wherein the configuration file set is a BLOB file set.

8. The method as claimed in claim 1 further comprising:
creating, by the processor, a temporary configuration file when the action is taken on an original configuration file associated with the FS;
replicating, by the processor, the configuration data from the original configuration file into the temporary configuration file; and
renaming, by the processor, the temporary configuration file as the original configuration file when the action is completed.

9. The method as claimed in claim 8 further comprising deleting, by the processor, the original configuration file upon renaming the temporary configuration file as the original configuration file.

10. A data storage system comprising:
a processor;
a file set creation module, coupled to the processor, to,
receive a request from a user to create a domain, wherein the domain is indicative of a storage device comprising at least one volume for storing data pertaining to a file system (FS);
determine whether the request is associated with a parameter; and
based on the determination, create a configuration file set within the domain; and
a data storage module, coupled to the processor, to, store configuration data within the configuration file set upon receiving a command from upper layers of the FS.

11. The data storage system as claimed in claim 10, wherein the data storage module is coupled to the processor to activate the configuration file set in a memory without utilizing a mount point, upon receiving the command from the upper layer of the FS.

12. The data storage system as claimed in claim 10 further comprising a tracking module, coupled to the processor, to,
create a temporary configuration file when a transaction is initiated from an original configuration file associated with the FS;
replicate the configuration data from the original configuration file into the temporary configuration file;
rename the temporary configuration file as the original configuration file when the transaction is completed; and
delete the original configuration file once the temporary configuration file is renamed as the original configuration file.

13. The data storage system as claimed in claim 12, wherein the tracking module is coupled to the processor to maintain a log of a plurality of steps involved in the action performed on the file.

14. The data storage system as claimed in claim 13, wherein the tracking module is coupled to the processor to:
determine if the FS has crashed before completion of the action on the file;
determine if a last entry in the log indicates the action is incomplete; and
upon determination, roll back steps performed for the action before the FS crashed.

15. A non-transitory computer-readable medium having a set of computer readable instructions that, when executed, cause a data storage system to:
create a configuration file set within a domain of a file system (FS), wherein the configuration file set is created upon receiving a request to create a domain, wherein the request is associated with a configuration parameter, and wherein the domain is indicative of a storage device comprising at least one volume for storing data pertaining to the FS;
associate a flag with the domain, wherein the flag is indicative of creation of the configuration file set in the domain;
activate the configuration file set to load data structures corresponding to the configuration file set in a memory without utilizing a mount point, wherein the activation is based on a command received from an upper layer of the FS to perform an action on the configuration file set; and
generate a file in the configuration file set, wherein the file contains configuration data pertaining to the FS.
